(19) United States
(12) Patent Application Publication
(10) Pub. No.: US 2005/0210740 A1
(43) Pub. Date: Sep. 29, 2005

(54) Edging strip having self-mating features

(76) Inventor: Daniel G. Zwier, Holland, MI (US)

Correspondence Address: FLYNN THIEL BOUTELL & TANIS, P.C., 2026 RAMBLING ROAD, KALAMAZOO, MI, 49008-1631, US

(21) Appl. No.: 11/138,095

(22) Filed: May 26, 2005

Related U.S. Application Data
(63) Continuation-in-part of application No. 10/991,102, filed on Nov. 17, 2004.
(60) Provisional application No. 60/523,568, filed on Nov. 20, 2003.

(51) Int. Cl. A01G 1/00

(52) U.S. Cl. 47/33

(57) ABSTRACT

An elongate edging strip includes top and bottom longitudinal edges, front and rear sides, and opposing ends. A first mating profile is formed on one of the front and rear sides, and/or proximate one of the top and bottom longitudinal edges or opposing ends. A second mating profile is formed on one of the front and rear sides corresponding to the first mating profile. One of the first and second mating profiles is configured to join a mating profile on a second elongate edging strip when the edging strips are properly oriented.

### CROSS-REFERENCE TO RELATED APPLICATIONS

This application is a continuation-in-part of co-pending U.S. patent application Ser. No. 10/991 102, filed Nov. 17, 2004, which claims the benefit of Provisional Application Ser. No. 60/523 568, filed Nov. 20, 2003.

### FIELD OF THE INVENTION

This invention relates generally to landscaping equipment and, more particularly, to an edging strip having mating features on only one side configured to allow, when there exists two or more of such strips and the aforesaid one sides face one another, two or more edging strips to become interconnected end to end or to form an endless edging construction or to be stacked edge-to-edge one on top of the other.

### BACKGROUND OF THE INVENTION

Edging strips are utilized in a number of landscaping applications. These strips are typically formed of elongated segments of extruded aluminum or plastic or rubber. The edging strips are positioned in the ground to form a boundary between a desired area, such as a flower bed or a pathway, and the remainder of the property. While these edging strips could theoretically be manufactured to any length, practicality limits the actual lengths of available edging strips. When two or more edging strips are needed to bound a desired area, it is preferable to mate the strips together to form a single elongate strip. Similarly, when an edging strip, or an elongate strip formed of two or more individual strips, is curved to bound a circular area, it is desirable to mate the ends of the strip together in an endless edging construction. Additionally, some planting beds or grassy areas that are to be bounded by the edging strips often contain root systems that extend deep into the ground. Thus, it is desirable to stack the edging strip edge-to-edge to enable a placement of edging deeper into the ground and yet have an upper edge exposed above the ground.

### SUMMARY OF THE INVENTION

The present invention is directed to an edging strip having improved mating features to allow for a reliable connection between two separate and mutually adjacent edging strip ends. The edging strip is an elongate segment of extruded material which has top and bottom edges and front and rear sides. Mating features are provided on only one side of the edging strip and two of such strips are configured to unite with each other only when the aforesaid one sides face one another, are initially axially offset from one another and thereafter one edging strip is slid axially relative to the other edging strip to thereby cause the mating features to interconnect.

### BRIEF DESCRIPTION OF THE DRAWINGS

Features and benefits of this invention will be understood by reference to the following detailed description, as well as by reference to the following drawings, in which:

FIG. 1 is an end view of an edging strip embodying the present invention;

FIG. 2 is a cross sectional view of two interlocked edging strip ends according to the FIG. 1 embodiment;

FIG. 3 is an end view of an alternate embodiment of an edging strip embodying the invention;

FIG. 4 is a fragmentary cross sectional view of two interlocked edging strips according to FIG. 3;

FIG. 5 is an end view of a still further embodiment of an edging strip embodying the invention;

FIG. 6 is a cross sectional view of two interlocked edging strips according to the FIG. 5 embodiment;

FIG. 7 is a fragmentary illustration of a modified bead structure;

FIG. 8 is an end view of the embodiment of FIG. 1 when the edging strips are stacked edge-to-edge one on top of the other;

FIG. 9 is an end view of the embodiment of FIG. 3 when the edging strips are stacked edge-to-edge one on top of the other; and

FIG. 10 is an end view of the embodiment of FIG. 5 when the edging strips are stacked edge-to-edge one on top of the other.

FIG. 11 is a perspective view of a further embodiment of an edging strip with self-mating features according to the invention.

FIG. 12 is a reverse perspective view of the edging strip of FIG. 11.

FIG. 13 is a partial cross-sectional view of the edging strip of FIGS. 11 and 12.

FIG. 14 is a partial cross-sectional view of the edging strip of FIGS. 11-13 in a stacked configuration.

FIG. 15 is a partial cross-sectional view of a further embodiment of an edging strip with self-mating features according to the invention.

FIG. 16 is a partial cross-sectional view of the edging strip of FIG. 15 in a stacked configuration.

FIG. 17 is a partial cross-sectional view of a further embodiment of an edging strip with self-mating features according to the invention.

FIG. 18 is a partial cross-sectional view of the edging strip of FIG. 17 and a stacked configuration.

FIG. 19 is a partial cross-sectional view of a further embodiment of an edging strip with self-mating features in a stacked configuration.

FIG. 20 is a side view of an edging strip with self-mating features according to a further embodiment of the invention.

FIG. 21 is a cross-sectional view taken through line 21-21 of FIG. 20.

FIG. 22 is a side view of a edging strip with self-mating features according to further embodiment of the invention.

FIG. 23 is a cross-section view taken through line 23-23 of FIG. 22.

FIG. 24 is a side view of an edging strip with a perforated stake slot knock out.

FIG. 25 is an end view of the edging strip of FIG. 24.

FIG. 26 is a side view of an edging strip with a perforated stake gate.

FIG. 27 is an end view of the edging strip of FIG. 26.

FIG. 28 is a side view of an edging strip with a stake loop.

FIG. 29 is an end view of the edging strip of FIG. 28.

FIG. 30 is a side view of an edging strip with a connector and two locking stakes.

FIG. 31 is a side view of an edging strip with an oversized stake slot.

FIG. 32 is a side view of an edging strip with an end-perforated stake slot.

FIG. 33 is a side view of an edging strip with a joining link.

FIG. 34 is an end view of a snap connection for an edging strip according to a further embodiment of the invention.

FIG. 35 is an assembled view of the edging strip of FIG. 34.

FIG. 36 is a side view of an edging strip according to a further embodiment of the invention.

FIG. 37 is a partial cross-sectional view of an assembled edging strip according to FIG. 36.

FIG. 38 is a side view of an edging strip according to a further embodiment of the invention.

FIG. 39 is a partial cross-sectional view of an assembled edging strip of FIG. 38.

FIG. 40 is a side view of an edging strip according to a further embodiment of the invention.

FIG. 41 is a partial cross-sectional view of an assembled edging strip according to FIG. 40.

FIG. 42 is an end view of an edging strip according to a further embodiment of the invention.

FIG. 43 is an assembled side view of the edging strip of FIG. 42.

FIG. 44 is a side view of an edging strip according to a further embodiment of the invention,

FIG. 45 is an assembled side view of the edging strip of FIG. 44.

FIG. 46 is a side view of an edging strip according to a further embodiment of the invention.

FIG. 47 is an assembled side view of the edging strip of FIG. 46.

FIG. 48 is a side view of an edging strip according to a further embodiment of the invention.

FIG. 49 is an end view of the edging strip of FIG. 48.

FIG. 50 is an assembled end view of the edging strip of FIGS. 48-49.

### DETAILED DESCRIPTION

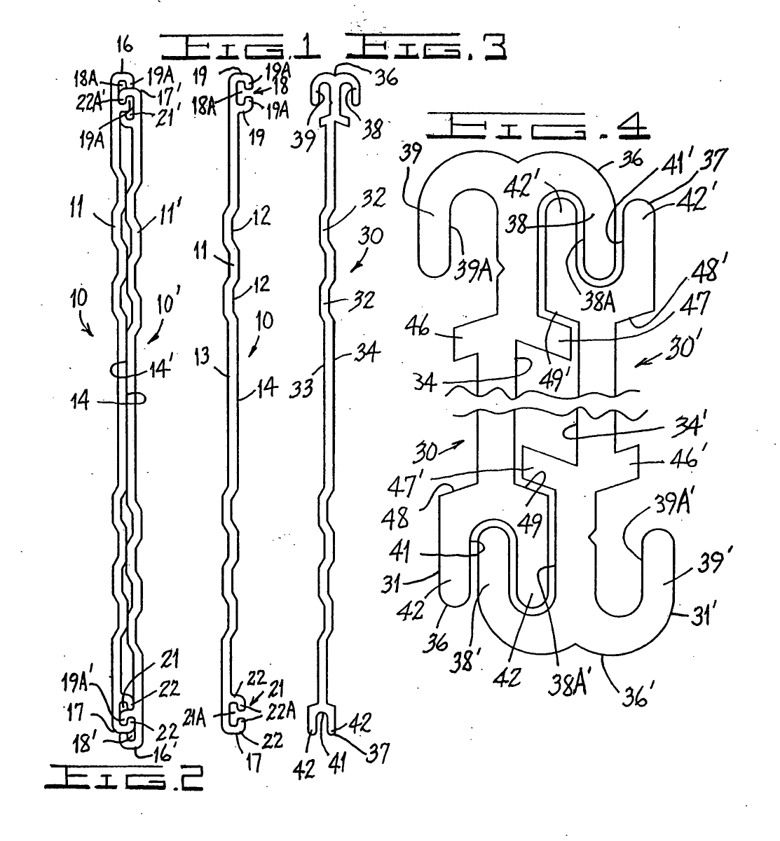

Referring to FIG. 1 there is illustrated an end view of an end 11 of an edging strip 10 according to the present invention. The edging strip 10 is preferably formed of an extruded material, such as aluminum or plastic or rubber and, if desired, includes a number of longitudinally extending reinforcing grooves 12 extending along the full length of the strip 10.

The edging strip 10 has a front side 13 and a rear side 14 and top and bottom edges 16 and 17. A side opening C-shaped or U-shaped channel 18 is formed adjacent the top edge 16 along the entire length of the edging strip 10. The channel 18 is defined by two spaced apart and generally parallel walls 19 which extend approximately perpendicularly outwardly from the rear side 14 of the edging strip 10. An identical side opening C-shaped or U-shaped channel 21 opening in the same direction as the channel 18 is formed along the entire length of the bottom edge 17 and also includes spaced apart and generally parallel walls 22 which extend approximately perpendicularly outwardly from the rear side 14 of the edging strip 10. The distal ends of each of the walls 19 are in the form of a right angle section as at 19A so that the interior of the channel 18 has a T-shape as depicted at 18A. Similarly, the distal ends of each of the walls 22 are in the form of a right angle section as at 22A so that the interior of the channel 21 has a T-shape as depicted at 21A.

FIG. 2 illustrates the mating of two edging strip ends 11 and 11′. The ends 11 and 11′ are ends of two different edging strips 10 and 10′, as illustrated. The second edging strip 10′ is identical to the edging strip 10 described above, and therefore, like features of the second strip 10′ have been and will be identified with like feature numbers and differentiated from the features of the first strip 10 by the prime (“′”) suffix.

The ends 11 and 11′ are positioned next to one another so that the rear sides 14 and 14′ oppose one another. This can be accomplished by turning one edging strip 180° from top to bottom or 180° left to right. In FIG. 2, the edging strip 10′ has been turned 180° top to bottom relative to the edging strip 10 and initially oriented axially offset therefrom. At least the wall section 22A′ is axially aligned with the channel 18 and at least the wall section 19A′ is axially aligned with the channel 21. This alignment will simultaneously cause the wall section 19A to become axially aligned with the channel 21′ and the wall section 22 to become axially aligned with the channel 18′. Thereafter, one edging strip may be slid axially relative to the other until the rear side 14 of the end 11 is directly opposing the rear side 14′ of the end 11′. The top edge 16 of the edging strip 10 is adjacent the bottom edge 17′ of the edging strip 10′ and the bottom edge 17 is adjacent the top edge 16′. Along the top edge 16, one of the distal ends 19A′ of the channel 18 is interlocked with one of the distal ends 22A′ of the channel 21′ so that the channel 18 is mated with the channel 21′, as illustrated. Similarly, and along the bottom edge 17, one of the distal ends 19A′ of the channel 18′ is interlocked with one of the distal ends 22 of the channel 21 so that the channel 21 is mated with the channel 18′, as illustrated. Since the distal ends 19A, 22A, 19A′ and 22A′ are in the form of wall sections extending at right angles to the respective walls 19, 19′ and 22, 22′, the edging strips 10 and 10′ will be locked together when the channels are mated. In order to avoid twisting of the edging strips, two or more edging strips can be mated in the manner illustrated in FIG. 2 to create either an endless edging construction or an elongated edging boundary.

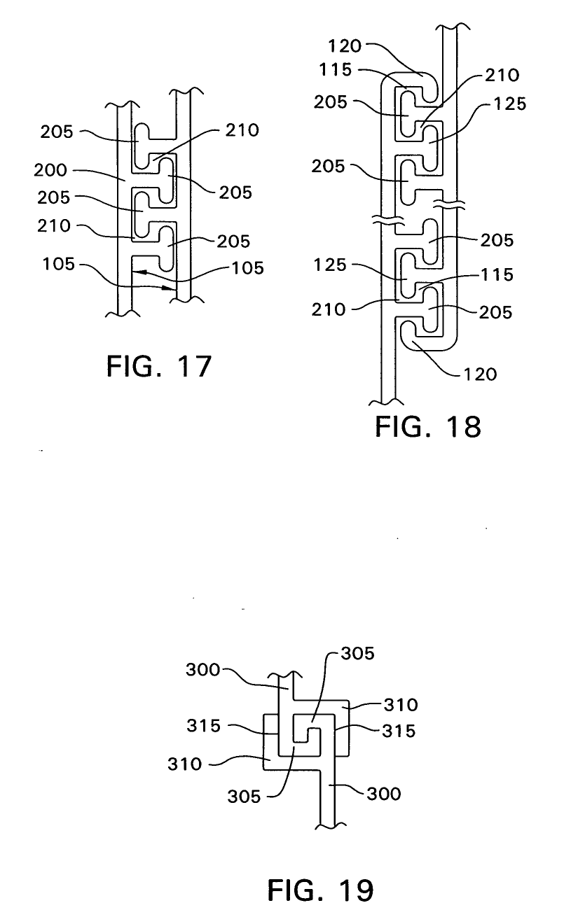

It is conceivable that the channels 18 and 21 could be located at locations other than at the top and bottom of the strip. If this is the case, care must be exercised to locate them equidistantly from the respective top and bottom to facilitate mating while maintaining flushness of the strips at the tops and bottoms. In addition, the T-shaped projections and channels can be placed in the middle of the strip in addition to the ends, as shown in FIGS. 17-18 to increase the stability of the connections.

Referring now to FIG. 3, there is illustrated an end view of an end 31 of an edging strip 30 according to an alternate embodiment of the present invention. The edging strip 30 has a number of longitudinally extending reinforcing grooves or reinforcing undulations 32 similar to the grooves 12 formed in the edging strip 10.

The edging strip 30 has a front side 33 and a rear side 34 and top and bottom edges 36 and 37. Adjacent the top edge 36 there are provided a pair of wall sections 38 and 39 which overlap the edging strip from opposite sides to form respective channels 38A and 39A both opening in a direction of and parallel to the general plane of the front and rear sides 33 and 34. Adjacent the bottom edge 37 there is provided two parallel walls 42 straddling the general plane of the edging strip 30 to define a U-shaped channel 41 thereat. The respective legs of the channel 41 are aligned with a corresponding one of the channels 38A and 39A on a common side of the edging strip 30.

FIG. 4 illustrates the mating of two edging strip ends 31 and 31′ of two edging strips 30 and 30′. Two edging strips 30 and 30′ are first aligned axially with the ends 31 and 31′ positioned next to one another so that the top and bottom ends 36 and 37 of the strip 30 are adjacent the bottom and top end 37′ and 36′, respectively, of the strip 30′. The rear side 34 of the strip 30 directly opposes the rear side 34′ of the strip 30′ during a relative axial installation movement to cause the wall section 39 of the end 31 to be received into the channel 41′ between the walls 42′. Similarly, the wall section 39′ of the end 31′ is received into the channel 41 between the walls 42. As with the previous embodiment, if the edging strip ends 31 and 31′ are the ends of two different edging strips 30 and 30′, the edging strip 30′ is merely turned upside down and positioned adjacent the edging strip 30 for mating.

Flanges 46 and 47 extend laterally outward from the front and rear sides 33 and 34 and the planes thereof are inclined or perpendicular to the plane of the edging strip. These flanges 46 and 47 (or 46′, 47′) are configured so that a surface thereon operatively engages further inclined or perpendicular surfaces 48′ and 49′ on a mutually adjacent and directly opposing edging strip and serve to guide the relative axially sliding movement of the edging strips when the walls 42, 42′ are received in channels 38′, 38 respectively.

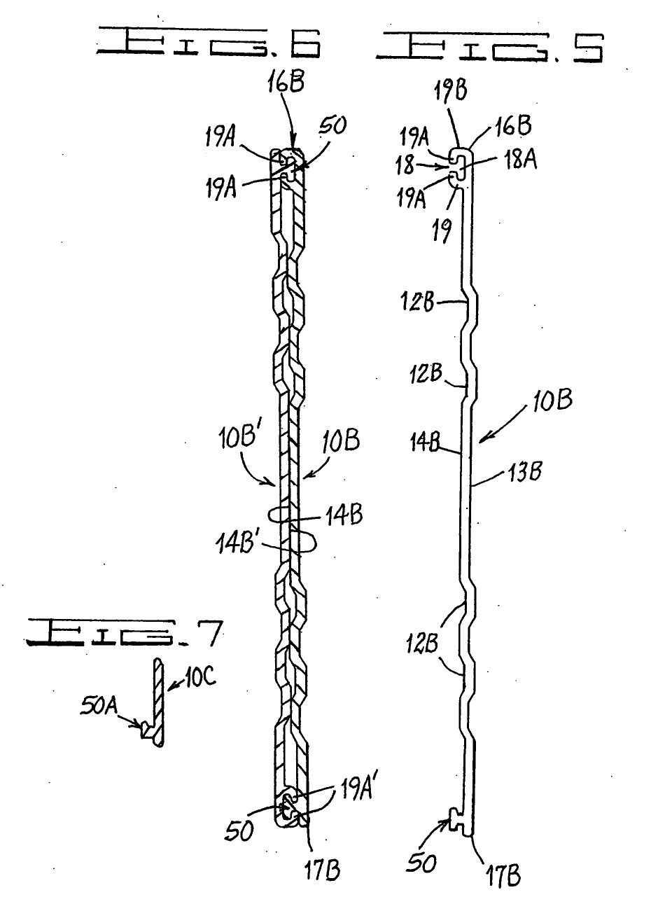

FIG. 5 illustrates a modified edging strip 10B similar to FIG. 1 except that the channel 21 has been replaced with an elongate T-shaped bead 50 extending outwardly from the rear side 14. This modified edging strip 10B will, for the structure componentry that is identical to the FIG. 1 structure, use the same reference character, but with the suffix “B” added thereto.

Referring now to the structure of the bead 50, it has a T-shaped cross section as depicted in FIG. 5. The size and shape of the T-shaped bead 50 is conformed to the size and shape of the channel 18A. Thus, when it is desired to mate the mutually adjacent ends of separate edging strips 10B and 10B′ as depicted in FIG. 6, the edging strip 10B′ is turned upside down and positioned adjacent the edging strip 10B so that the T-shaped bead 50′ is axially aligned with the T-shaped channel 18A and the bead 50 is axially aligned with the T-shaped channel 18A′ so that one edging strip can be slid axially relative to the other so that the beads 50 and 50′ will enter, respectively, the channels 18A′ and 18A. It will be noted that when the strips 10B and 10B′ are mated as shown in FIG. 6, the top and bottom edges are flush with each other to provide an aesthetically pleasing appearance when installed.

It is deemed to be within the scope of this invention to provide on a modified edging strip 10C a bead 50A (see FIG. 7) that is L-shaped instead of the T-shaped bead 50 depicted in FIG. 5.

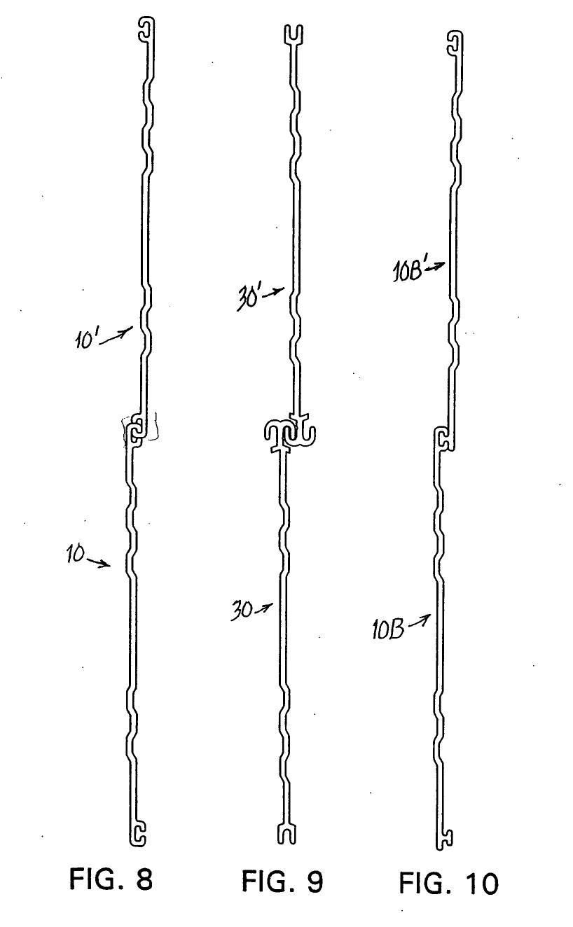

As is depicted in FIGS. 8-10, each of the previously described embodiments of FIGS. 1, 3 and 5 can be stacked edge-to-edge one on top of the other in order to accommodate installations that are to extend deep into the ground. If desired, each strip can have an integrally formed ribbon of material forming a loop oriented about a common vertical axis when the strips are stacked in order to accommodate a stake extending therethrough.

Referring now to FIGS. 11-14, a further embodiment of an edging strip 100 having self-mating features is disclosed. Each edging strip 100 includes a front side 105 including the self-mating features and a rear side 110 lacking these features. Each edging strip 100 includes upper and lower T-shaped channels 115. The T-shaped channels 115 are formed by an overturned upper or lower edge 120 of the edging strip 100 and a T-shaped bead 125. The T-shaped channel 115 is configured to closely receive the T-shaped bead 125 of a like edging strip 100. The T-shaped channel 115 is also configured to receive the overturned edge 120 of an edging strip 100. The edging strips 100 can be provided with anchor slots 130. The anchor slots 130 of the respective edging strips 100 can be aligned and an anchor 135 inserted therethrough to lock the edging strips, preventing longitudinal movement therebetween.

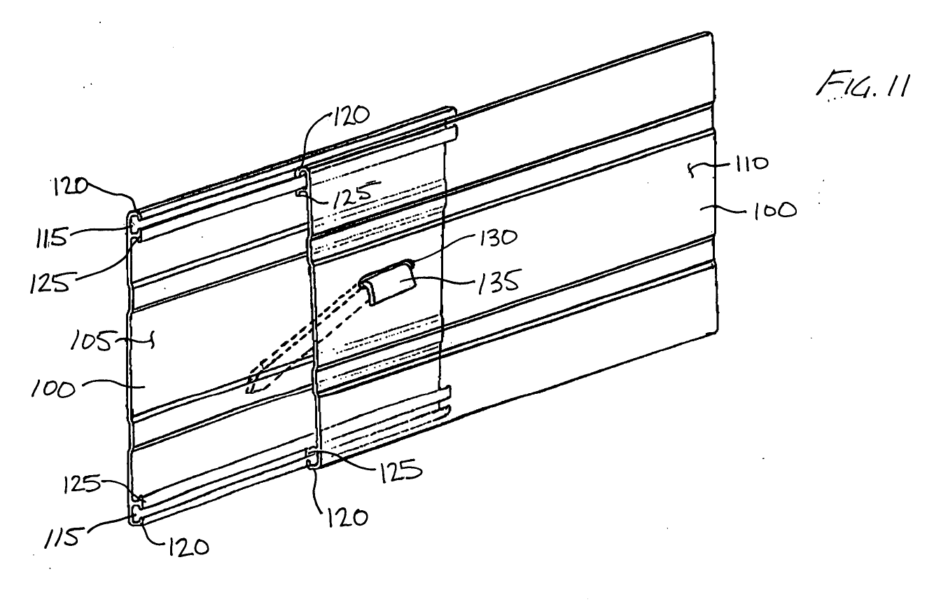

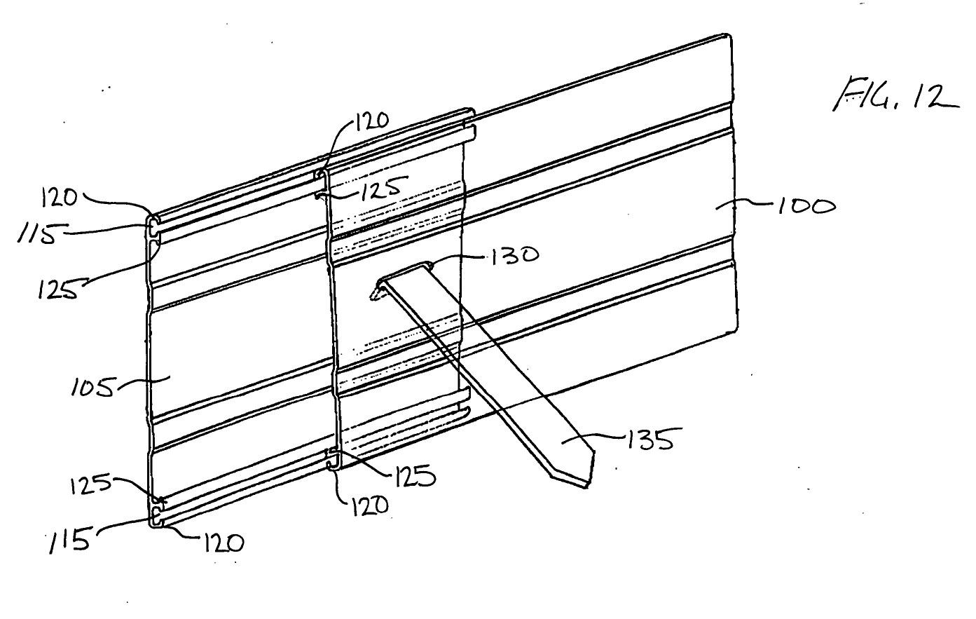

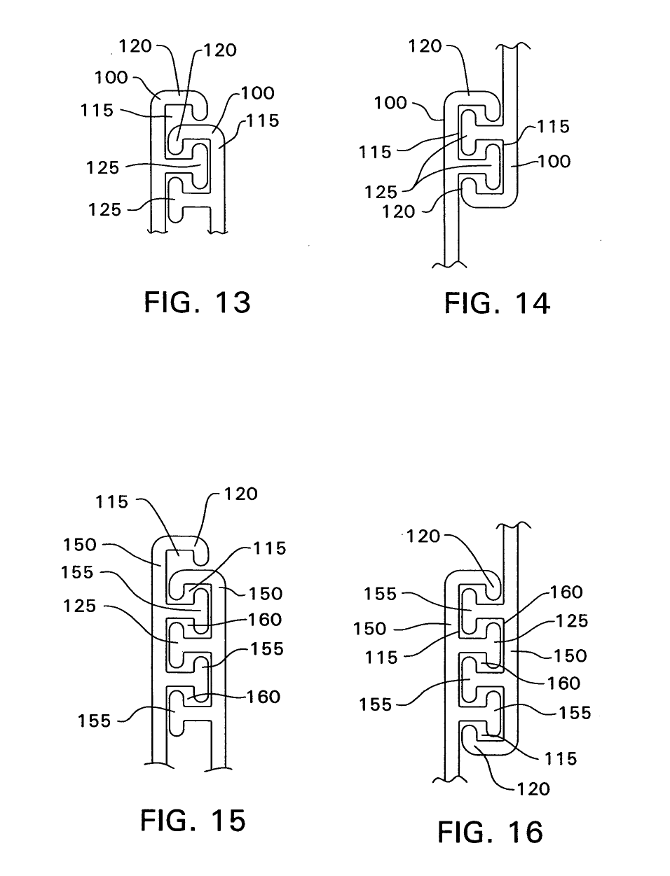

FIG. 13 is an enlarged detail view of the connection between the edging strips 100, wherein the T-shaped bead 125 of the edging strip 100 on the left is received in the T-shaped channel 115 of the edging strip on the right. The overturned edge 120 of the edging strip 100 on the right is corresponding received with the T-shaped channel 115 of the edging strip 100 on the left, interlocking the two edging strips 100. A complimentary arrangement is realized on the bottom edge of the edging strips 100.

In an alternative configuration of the edging strips 100, the edging strips 100 can be arranged in a stacked fashion wherein an edging strip having a greater height is required. As show in FIG. 14, the lower edge 120 of the edging strip 100 on the right is aligned with the upper edge of the edging strip 100 on the left. The T-shaped bead 125 of each edging strip 100 is received in the T-shaped channel 115 of the opposing edging strip 100, locking the edging strips 100 together in a stacked configuration.

A further embodiment of an edging strip 150 is shown in FIGS. 15-16. In this embodiment, a second T-shaped bead 155 is aligned inboard of the first T-shaped bead 125, thereby forming a second T-shaped channel 160. The edging strips 150 are connected in much the same manner as the edging strips 100 of the previous embodiment. In like manner, FIG. 16 illustrates a stacked configuration of the edging strips 150.

In a further embodiment of an edging strip 200, an additional pair of T-shaped beads 205, 210 are provided on the face 105 of the edging strip 200. In the pictured embodiment, the T-shaped beads 205, 210 are positioned in a mid-range of the face 105 and are configured to engage one another while the upper and lower edges of the edging strip 200 are also so engaged. Referring to FIG. 18, the positioning of the T-shaped beads 205, 210 in the midrange of the face 105 provides an additional configuration for stacking the edging strips 200, wherein a lower edge of the right hand edging strip 200 engages the T-shaped beads 205, 210 of the left hand edging strip 200 while the edge of the left hand edging strip 200 engages the T-shaped beads 205, 210 of the right hand edging strip 200. In this manner, an intermediate stacked configuration shorter than the full stacked configuration is achieved.

Referring now to FIG. 19, a further embodiment of a stacking configuration of an edging strip 300 is disclosed. The edging strip 300 includes an overturned edge 305 and an L-shaped bead 310 that extends beyond the overturned edge 305, creating a J-shaped channel 315. The J-shaped channel 315 is configured for receiving that portion of the overturned edge 305 of the respective edging strip 300 that extends beyond the L-shaped bead 310.

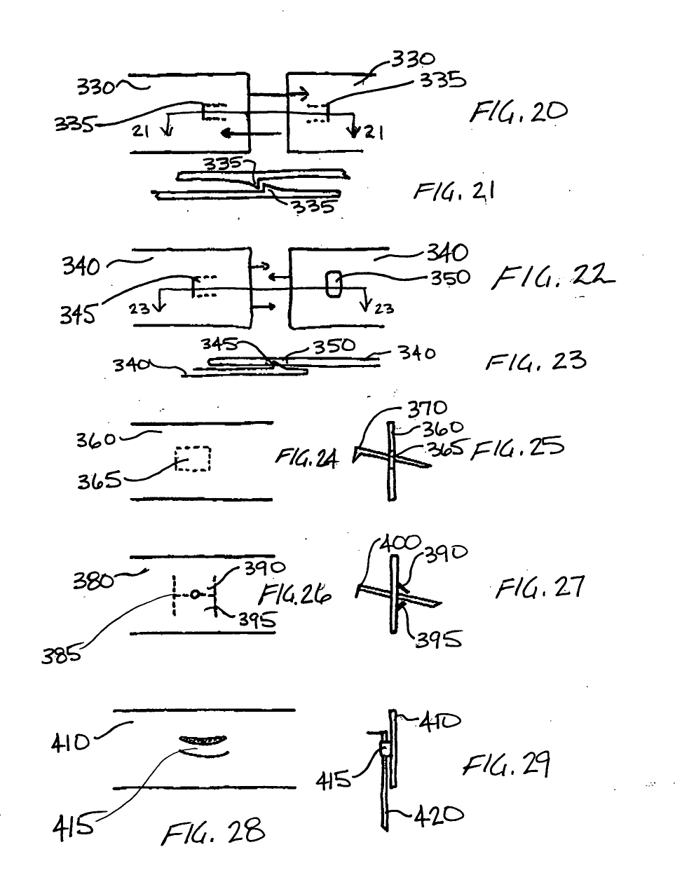

FIGS. 20-21 disclose a configuration whereby each of the edging strips 330 include a lanced portion 335. As the edging strips 330 are drawn together longitudinally, the lanced portions 335 overlap and lock preventing the longitudinal separation of the edging strips 330.

FIGS. 22-23 disclose a pair of edging strips 340, whereby a first end of the edging strip 340 includes a lanced portion 345 and a second end of the edging strip 340 includes an aperture 350. As the edging strips 340 are overlapped longitudinally, the lanced portion 345 of the first edging strip 340 is received in the aperture 350 of the second edging strip 340, preventing the longitudinal separation of the edging strips.

Referring now to FIGS. 24-25, an edging strip 360 is provided with a perforated stake knock-out 365. The perforated stake knock-out 365 is configured to be easily removed during installation of the edging strip 360 for receiving an anchor stake 370. When an anchor stake 370 is not required in a particular position, the perforated stake slot 365 can be left intact to present an uninterrupted edging strip 360.

FIGS. 26-27 illustrate an edging strip 380 having a perforated stake gate 385. The perforated stake gate 385 includes an upper flap 390 and a lower flap 395. Upon insertion of a stake 400 through the stake gate 385, the upper and lower flaps 390, 395 are displaced to the side without separating from the edging strip 380. When a stake 400 is not in use, the perforated stake gate 380 is left in place presenting an uninterrupted surface of the edging strip 380.

Referring now to FIGS. 28-29, an edging strip 410 is shown including a stake loop 415. The stake loop 415 projects outward from a face of the edging strip 410 and is configured for receiving a vertical insertion of an anchor stake 420.

Referring now to FIG. 30, an edging strip 430 is provided with a stake slot 435 approximate an end portion 440 thereof. A separate connector piece 445 having stake slots 450 is provided to overlap the end portion 440 of each edging strip 430. A pair of stakes 455 is then inserted through the slots 435, 450 of the connector 445 and the edging strips 430 to anchor the assembly together.

Referring now to FIG. 31, an edging strip 460 is provided with an elongated stake slot 465. The stake slot 465 is configured to receive a stake 470 and allows for thermal longitudinal expansion of the edging strip 460 due to environmental conditions.

FIG. 32 illustrates a further edging strip 480 having a stake slot 485 with perforated edge portions 490. The stake slot 485 is configured to receive an anchor stake 495. The perforated edges 490 of the stake slot 485 permit the longitudinal movement of the edging strip 480 due to thermal expansion, but when not so expanded present an uninterrupted surface of the edging strip 480.

Referring now to FIG. 33, an edging strip 500 includes an aperture 505 proximate an end 510 thereof. The apertures 505 are configured for receiving a joining link 515 for holding the edging strips 500 longitudinally together.

Referring to FIGS. 34-35, a further embodiment of an edging strip 520, 525 with mating features is disclosed. The edging strip 520 includes a T-shaped bead 530. The edging strip 525 includes a pair of inwardly turned flexible arms 535 configured to receive the T-shaped bead 530 in a snap-fit configuration as shown in FIG. 35. The edging strip 525 shown in FIGS. 34-35 can also be configured as a connector for joining like edging strips 520, each having the T-shaped bead 530.

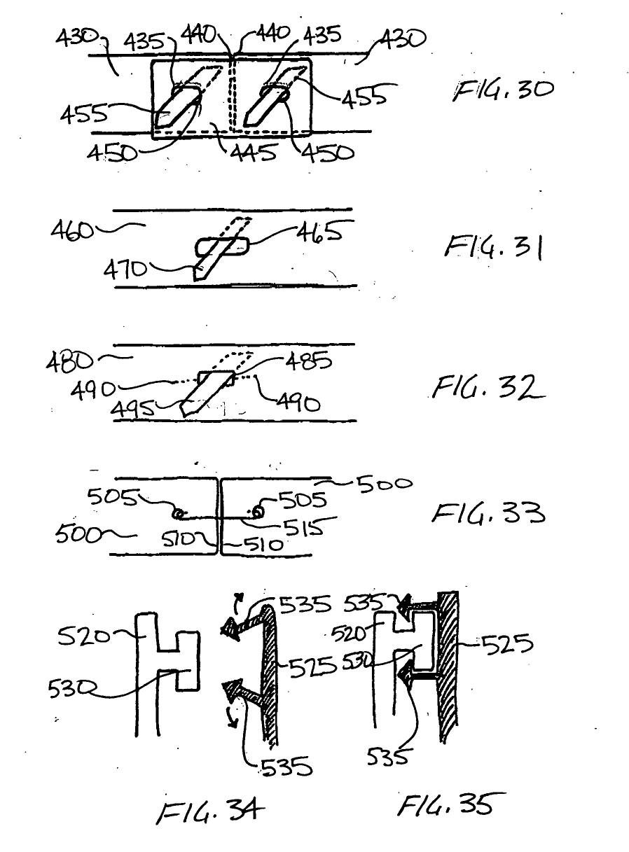

FIGS. 36-41 disclose purpose-built end configurations for edging strips. FIGS. 36-37 illustrate an edging strip 550 having a T-shaped or keyhole aperture 555. A corresponding edging strip 560 includes a tab 565 having an enlarged head for receipt in the keyhole aperture 555.

FIGS. 38-39 illustrate an edging strip 570 having a longitudinally extending tab 575 with a laterally extending pin 580. In a corresponding position on an opposing edging strip 570, an aperture 585 is positioned for receiving the pin 580.

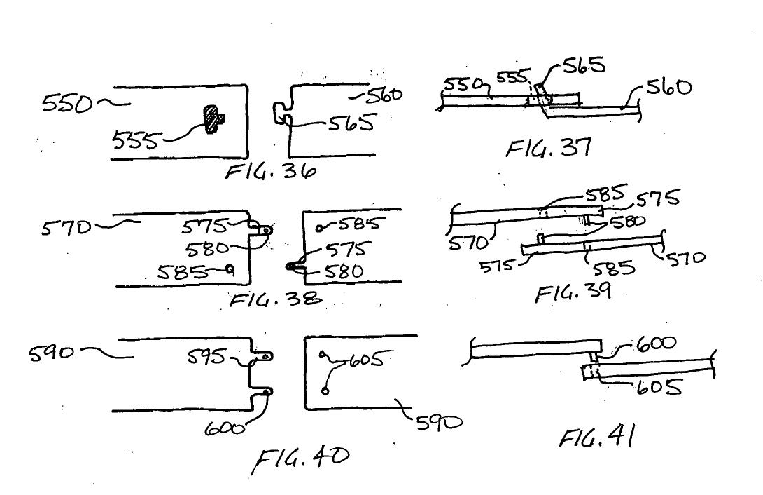

In FIGS. 40-41 the edging strip 590 includes at a first end a pair of tabs 595 each having a laterally extending pin 600. At an opposing end, the edging strip 590 includes a pair of apertures 605 configured and aligned to receive the pins 600.

FIGS. 42-43 disclose a C-channel design for an edging strip 610. In this configuration, a portion of the upper and lower lips 615, 620 is removed from the edging strip 610, leaving a central portion 625 of the C-channel for insertion in the channel of the opposing edging strip 610.

Referring to FIGS. 44-45, an end portion 630 of an edging strip 635 includes a longitudinal slot 640. The longitudinal slot 640 of adjacent edging strips 635 are aligned so that the opposing strips 635 can overlap in a hand-shake type connection shown in FIG. 45.

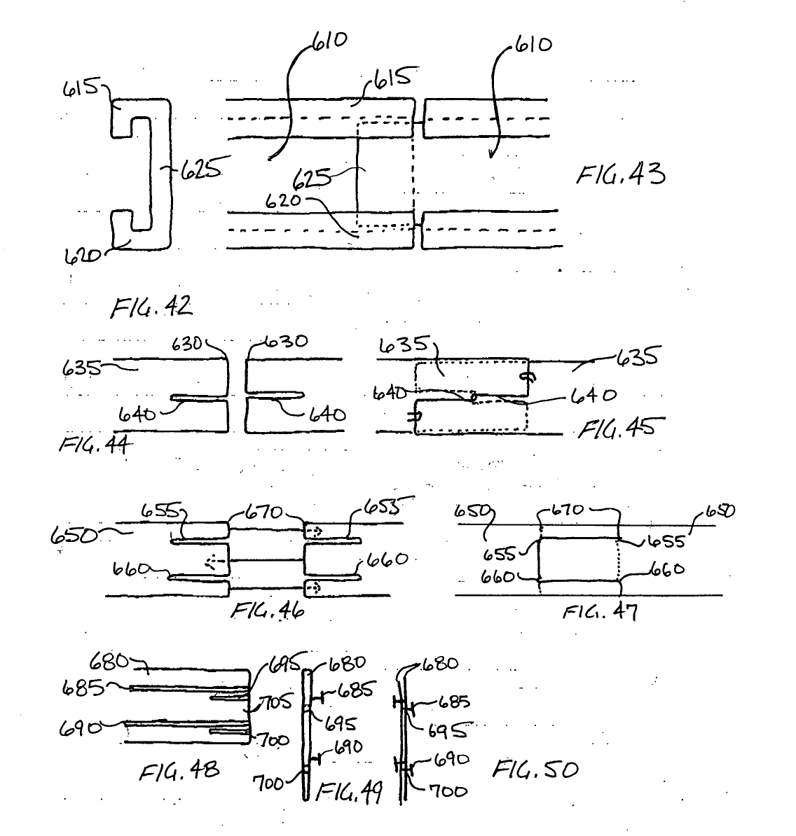

FIGS. 46-47 disclose an edging strip 650 having a pair of longitudinal slots 655, 660 in an end portion 670 thereof. In a like fashion to the embodiment of FIGS. 44-45, the slots 655, 660 are aligned and the end portions 670 of the edging strips 650 woven together, as shown in FIG. 47.

Referring now to FIGS. 48-50, an edging strip 680 is provided with a pair of T-shaped beads 685, 690 running longitudinally along the edging strips 680. A pair of spaced slots 695, 700 are provided or formed at an end portion 705 of the edging strip 680. The slots 695, 700 are spaced to receive the T-shaped beads 685, 690 of the corresponding edging strip 680 so that the slots 695, 700 of a first edging strip receive the T-shaped beads 685, 690 of the opposing edging strip 680, and vice versa.

Although particular preferred embodiments of the present invention have been disclosed in detail for illustrative purposes, it will be recognized that variations or modifications lie within the scope of the present invention and do not depart from the spirit of the invention, as set forth in the foregoing description and drawings, and in the following claims.

1. An elongate edging strip having top and bottom longitudinal edges, front and rear sides, and opposing ends, the edging strip comprising:
a first mating profile formed on one of said front and rear sides and extending coextensively therewith; and
a second mating profile formed on one of said front and rear sides and corresponding to said first mating profile extending coextensively therewith,
said first and second mating profiles being configured so that at least one of said first and second mating profiles on separate edging strips can be joined with each other only when said edging strips are oriented so that said one side on each edging strip opposes the other but is vertically offset therefrom and respective said at least one of said first and second mating profiles are axially aligned to facilitate one edging strip being moved axially relative to the other edging strip to cause said at least one of said first and second mating profiles to interconnectingly mate with each other and become connected to each other and incapable of. separation in a direction perpendicular to a plane containing a respective said strip.

2. The edging strip according to claim 1, wherein said first and second mating profiles are each a side opening C-shaped or U-shaped channel oriented at said top and bottom longitudinal edges and which extend coextensively with said one side.

3. The edging strip according to claim 1, wherein said first and second mating profiles each include a pair of opposing walls defining a C-shaped or U-shaped channel.

4. The edging strip according to claim 1, wherein said first and second mating profiles are each U-shaped channels opening in a direction parallel to a plane of said edging strip.

5. The edging strip according to claim 1, wherein one of said first and second mating profiles is a side opening C-shaped or U-shaped channel which extends along at least one of said front side and said rear side and having therein a channel that is T-shaped in cross section; and
wherein an other of said first and second mating profiles is a raised bead configured to conform at least in part in size and shape to a size and shape of said channel.

6. The edging strip according to claim 5, wherein said raised bead is T-shaped in cross section.

7. The edging strip according to claim 5, wherein said raised bead is L-shaped in cross section.

8. The edging strip according to claim 1, wherein said first and second mating profiles on separate identical edging strips are united with each other only when said edging strips are oriented so that said one side on each oppose one another but are axially offset and respective said first and second mating profiles are axially aligned to facilitate one edging strip being moved axially relative to the other edging strip to cause said first and second mating profiles to interconnectingly mate with each other and become connected to each other and incapable of separation in a direction perpendicular to a plane containing a respective said strip.

9. The elongate edging strip of claim 1, wherein at least one of said first and second mating profiles includes a T-shaped bead and a T-shaped channel.

10. The elongate edging strip of claim 9, wherein at least one of said first and second mating profiles includes two T-shaped beads and two T-shaped channels.

11. An elongate edging strip having top and bottom longitudinal edges, front and rear sides, and opposing ends, the edging strip comprising:
a first mating profile formed on one of said front and rear sides and extending coextensively therewith; and
a second mating profile formed on one of said front and rear sides corresponding to said first mating profile and extending coextensively therewith,
at least one of said first and second mating profiles being configured to join at least one of said first and second mating profiles on a like configured edging strip only when said edging strips are oriented so that said one of said front and rear sides on each edging strip faces the other and respective said at least one of said first and second mating profiles are aligned to facilitate one edging strip being moved relative to the other edging strip to cause said at least one of said first and second mating profiles to mate with each other and become connected to each other and incapable of separation in a direction perpendicular to a plane containing a respective said edging strip.

12. The elongate edging strip according to claim 11, wherein at least one of said first and second mating profiles is formed proximate one of said top and bottom longitudinal edges.

13. The elongate edging strip according to claim 12, wherein said first and second mating profiles are formed on a common side of said edging strip.

14. The elongate edging strip according to claim 11, wherein said first and second mating profiles are formed on a common side of said edging strip.

15. The elongate edging strip according to claim 11, further comprising an aperture near an end thereof, configured for receiving a connector to an adjacent edging strip.

16. The elongate edging strip of claim 11, wherein at least one of said first and second mating profiles includes a T-shaped bead and a T-shaped channel.

17. The elongate edging strip according to claim 16, wherein one of said mating profiles includes a pair of resilient arms for engaging said T-shaped bead in a snap-fit connection.

18. The elongate edging strip according to claim 11, wherein the edging strips are longitudinally secured by a stake passing through an aperture in a planar face thereof.

19. The elongate edging strip according to claim 11, further comprising at least one aperture therethrough configured for receiving an anchor stake.

20. The elongate edging strip according to claim 19, wherein said aperture is configured with a width greater than that of an edging stake to permit for longitudinal thermal expansion of said edging strip.

21. The elongate edging strip according to claim 11, further comprising a knock-out stake opening.

22. The elongate edging strip according to claim 11, further comprising a perforated stake gate.

23. The elongate edging strip according to claim 11, further comprising a stake loop extending from at least one of said front side and said rear side.

24. An elongate edging strip having top and bottom longitudinal edges, front and rear sides, and opposing ends, the edging strip comprising:
a first mating profile formed on one of said front and rear sides and extending coextensively therewith; and
a second mating profile formed on one of said front and rear sides corresponding to said first mating profile and extending coextensively therewith,
at least one of said first and second mating profiles being configured to join at least one of a third and a fourth mating profile on a second edging strip.

25. The elongate edging strip according to claim 24, wherein the mating profile of the first edging strip is different than the mating profile of the second edging strip.

26. The elongate edging strip according to claim 24, wherein each of the respective mating profiles extends from a longitudinal edge of the edging strip.

27. The elongate edging strip according to claim 24, wherein a first end of said edging strip is symmetrical with a second end thereof.

28. The elongate edging strip according to claim 27, wherein said first end of said edging strip is configured to mate with said second end thereof.

29. The elongate edging strip according to claim 24, wherein a first end of said edging strip is configured to mate with a second end thereof.

30. The elongate edging strip according to claim 24, wherein said edging strip is configured for cutting a mating profile in an end thereof.

31. The elongate edging strip according to claim 24, wherein said edging strip includes a slot in an end thereof for receiving the mating profile of an opposing strip.

32. The elongate edging strip according to claim 24, wherein said edging strip includes a slot in an end thereof configured to interact with a corresponding slot on an opposing edging strip for interweaving said edging strips.

33. The elongate edging strip according to claim 24, wherein said second edging strip is configured to have a portion cut away to form said third and fourth mating profiles to enable interconnection between said edging strips at respective ends thereof.
